(19) United States
(12) Patent Application Publication
(10) Pub. No.: US 2026/0172664 A1
(43) Pub. Date: Jun. 18, 2026

(54) IMAGE CAPTURING APPARATUS, CONTROL METHOD THEREOF, AND STORAGE MEDIUM

(71) Applicant: CANON KABUSHIKI KAISHA, Tokyo (JP)

(72) Inventor: MASAAKI UENISHI, Kanagawa (JP)

(21) Appl. No.: 19/401,923

(22) Filed: Nov. 26, 2025

(30) Foreign Application Priority Data
Dec. 12, 2024 (JP) 2024-217758

(51) Int. Cl. H04N 23/611; G06F 3/16; H04N 23/55; H04N 23/63

(52) U.S. Cl. CPC H04N 23/611; G06F 3/167; H04N 23/55; H04N 23/632

(57) ABSTRACT

An image capturing apparatus includes an image capturing device, a recognition unit that recognizes a shooting scene and a feature of a shooting object, a generation unit that generates a shooting parameter of the image capturing device, a display device, an acquisition unit that acquires an instruction for modification from a user with respect to an image displayed on the display device, and a control unit that performs capturing with the image capturing device based on the shooting parameter, acquires the instruction for modification from the user with respect to the image, and repeats a series of operations of generating a modified shooting parameter of the image capturing device based on the combined information and the instruction for modification from the user to perform learning of the learning model.

### BACKGROUND

### Field of the Technology

The present disclosure relates to a technique for assisting shooting in an image capturing apparatus.

### Description of the Related Art

In an image capturing apparatus such as a digital camera, a user's manual setting of many shooting parameters such as shutter speed, aperture, and ISO sensitivity is poor in operability, and it is also difficult to quickly set the shooting parameters for a moving subject. Therefore, in recent years, most image capturing apparatuses have an automatic shooting mode in which shooting parameters are automatically set according to a shooting scene.

Japanese Patent Laid-Open No. 2019-213130 discloses a technique of determining a shooting scene based on a live view image and displaying a shooting parameter matching the shooting scene together with a setting recommended range. According to Japanese Patent Laid-Open No. 2019-213130, it is possible to assist shooting by visually indicating, to the user, a basic setting item suitable for the user and prompting a change in setting content.

In the technique disclosed in Japanese Patent Laid-Open No. 2019-213130, a camera determines a shooting scene, and accordingly displays a shooting parameter. However, there are cases where the setting is not an appropriate setting as preferred by the user since the shooting parameter does not reflect the intention of the user.

### SUMMARY

The present disclosure has been made in view of the above-described problem, and provides an image capturing apparatus that can set a shooting parameter to an appropriate value preferred by a user.

According to an aspect of the present disclosure, there is provided an image capturing apparatus comprising: an image capturing device that captures a subject to acquire an image signal; and at least one processor or circuit and a memory storing instructions to cause the at least one processor or circuit to perform operations of the following units: a recognition unit that recognizes a shooting scene and a feature of a shooting object based on the image signal, a generation unit that generates a shooting parameter of the image capturing device corresponding to combined information by using a learning model that learns a relationship between the combined information associating the shooting scene with the feature of the shooting object and a shooting parameter that gives an appropriate shooting result with respect to the combined information, a display device that displays the image captured with the image capturing device based on the shooting parameter generated by the generation unit, an acquisition unit that acquires an instruction for modification from a user with respect to an image displayed on the display device, and a control unit that performs capturing with the image capturing device based on the shooting parameter generated by the generation unit, displays a captured image on the display device, acquires the instruction for modification from the user with respect to the image displayed on the display device, and repeats a series of operations of generating a modified shooting parameter of the image capturing device by the generation unit based on the combined information and the instruction for modification from the user to perform learning of the learning model so as to obtain a shooting parameter desired by the user.

Features of the present disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are system configuration diagrams of a digital camera that is a first embodiment of an image capturing apparatus of the present disclosure.

FIG. 2 is an external view of a digital camera.

FIG. 3A is a flowchart showing an operation of the digital camera.

FIG. 3B is a flowchart showing an operation of the digital camera.

FIG. 4 is a conceptual view illustrating an operation of the digital camera described with reference to FIGS. 3A and 3B.

FIG. 5 is a view illustrating a configuration example of a generation unit including one learning model.

FIG. 6 is a view illustrating a data array of input data of the generation unit.

FIG. 7 is a view illustrating a configuration of a digital camera of a second embodiment.

FIG. 8 is a view illustrating a configuration of a line-of-sight detection unit.

FIG. 9 is an explanatory view of a principle of a line-of-sight detection method.

FIGS. 10A and 10B are schematic views of an eyeball image projected on an eyeball image sensor.

FIG. 11 is a schematic flowchart of line-of-sight detection processing.

FIG. 12A is a flowchart showing an operation of the digital camera in the second embodiment.

FIG. 12B is a flowchart showing an operation of the digital camera in the second embodiment.

FIG. 13 is a conceptual view illustrating an operation of the digital camera described with reference to FIGS. 12A and 12B.

FIG. 14 is a view illustrating a configuration example of a generation unit including one learning model in the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

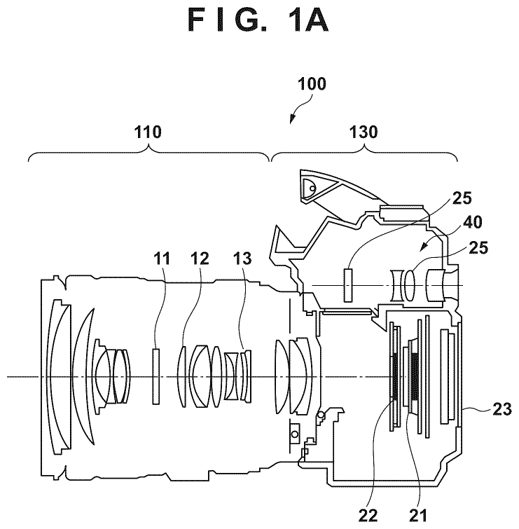

Hereinafter, the first embodiment of the present disclosure will be described with reference to FIGS. 1A to 6.

### System Configuration of Digital Camera

FIGS. 1A and 1B are views illustrating a system configuration of a digital camera 100 that is the first embodiment of the image capturing apparatus of the present disclosure.

FIG. 1A is a view illustrating a mechanical configuration of the digital camera 100. A shooting optical system 110 includes an aperture 11, a camera shake correction lens group 12, and a focus lens group 13, and can guide subject light to a camera body 130. The camera body 130 includes an image sensor 21 that photoelectrically converts an optical image formed by the shooting optical system 110 and a mechanical shutter 22 that adjusts an exposure time.

The camera body 130 includes a rear liquid crystal device 23 on a rear part, and a small liquid crystal device 24 and an optical system 25 on a finder unit 40, and can display an image captured by the image sensor 21. Note that the mechanical shutter is unnecessary as long as the image sensor includes an electronic shutter function, and even in a case where the image sensor includes a mechanical shutter, the mechanical shutter remains fully opened in a case where the exposure time is adjusted with the electronic shutter. At the time of shooting, a shutter button not illustrated is shallowly pressed to the first stage, that is, what is called “half-press” (hereinafter, called SW1 pressing), whereby automatic focus adjustment is performed, and shooting parameters such as a shutter speed and an aperture value are set by an automatic exposure mechanism. Furthermore, the shutter button is deeply pressed from half-press to the second stage, that is, what is called “full-press” (hereinafter, called SW2 pressing), whereby the electronic shutter function of the mechanical shutter 22 or the image sensor 21 operates to perform capturing.

FIG. 1B is a view illustrating an electrical configuration of the digital camera 100. The camera body 130 includes an electric circuit 30, and a CPU 31, an image processing unit 32, a control unit 33, a generation unit 34, a voice acquisition unit 35, and the like are arranged in the electric circuit 30. A memory 36 that stores image data, programs, and the like is connected to the electric circuit 30. The aperture 11, the camera shake correction lens group 12, the focus lens group 13, and the mechanical shutter 22 are each driven and controlled by the control unit 33 via a driving means not illustrated.

An image signal generated by photoelectric conversion in the image sensor 21 is output as digital data from the image processing unit 32 and stored in a recording medium not illustrated. The image processing unit 32 performs processing of recognizing a shooting scene from shot image data and processing of recognizing a feature of a shooting object.

The finder unit 40 further includes an eye contact sensor 26, and can detect whether or not a shooter has eye contact on the finder unit 40. The camera body 130 includes the voice acquisition unit 35, and can process voice input with a microphone 27. The generation unit 34 includes a neural network, and is a processing unit that generates a modified image that is a new image and a shooting parameter for shooting the modified image from the image data based on learning. This will be described in detail below.

The CPU 31 is a processing apparatus that can electrically control all the above-described elements. In FIGS. 1A and 1B, a control signal line is omitted, and only a flow of information among elements is indicated by arrows.

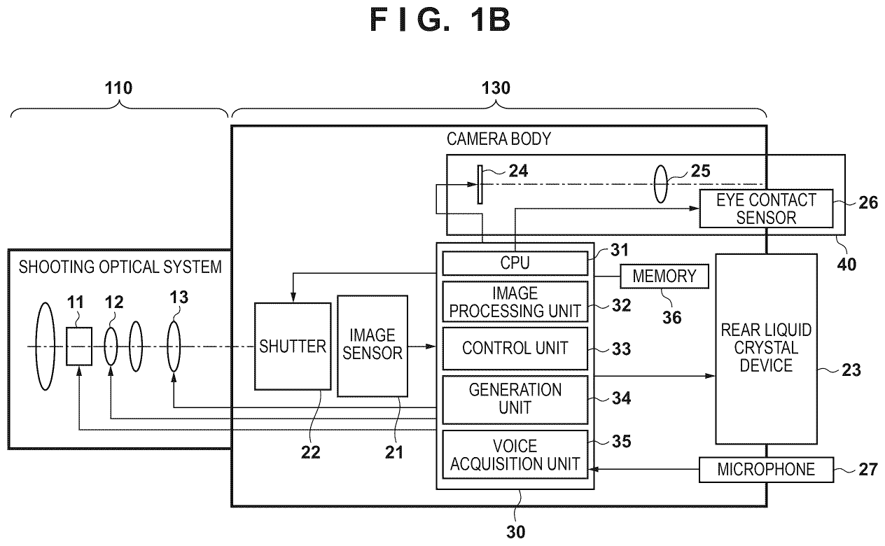

FIG. 2 is an external view of the digital camera 100. The same blocks as those in FIGS. 1A and 1B are denoted by the same reference signs.

The user changes the shooting parameter using an operation unit 202 and an electronic dial 204, which are setting changing means such as a button attached to the image capturing apparatus, and performs shooting. Note that the rear liquid crystal device 23 may have a touch panel function, and the rear liquid crystal device 23 may allow a change of the shooting parameter. The user can grasp a current setting status of the shooting parameter by display output by the rear liquid crystal device 23 or the small liquid crystal device 24.

### Generation Unit 34

The digital camera 100 has a wide variety of shooting parameters. Representative shooting parameters are ISO sensitivity, aperture value, shutter speed, exposure correction value, white balance setting, contrast, and the like. Of course, other parameters that affect a shot image can also be included. For example, chroma, sharpness, lighting correction, tone priority, shooting style, noise reduction, color correction, and the like, which are parameters related to image processing, may also be included.

Users have different photographic preferences, and information on a focus position such as a case of focusing on a plurality of subjects or a case of focusing on a specific subject may be included in the shooting parameter.

The generation unit 34 is a processing unit including a learning model (large language model in the present embodiment) that can present a modified image and a shooting parameter matching the preference of the user based on a shooting status and information on an instruction by the user. The learning model includes, for example, a multilayer neural network.

In the present embodiment, the generation unit 34 performs inference processing with the shooting scene, the feature of the shooting object, and the user instruction information (prompt) by voice as inputs, and generates a shooting parameter. A learning method will be described later.

### Operation Flow of Camera

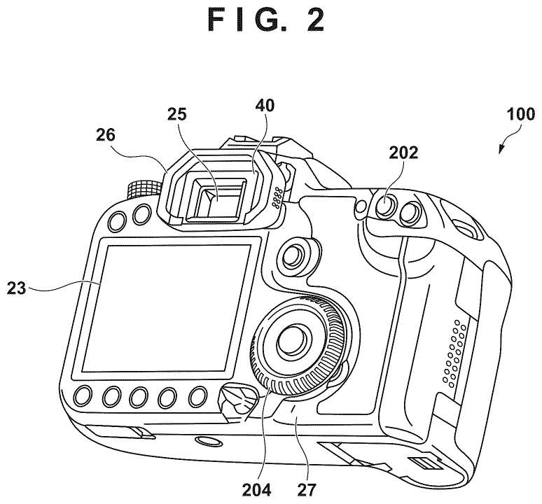

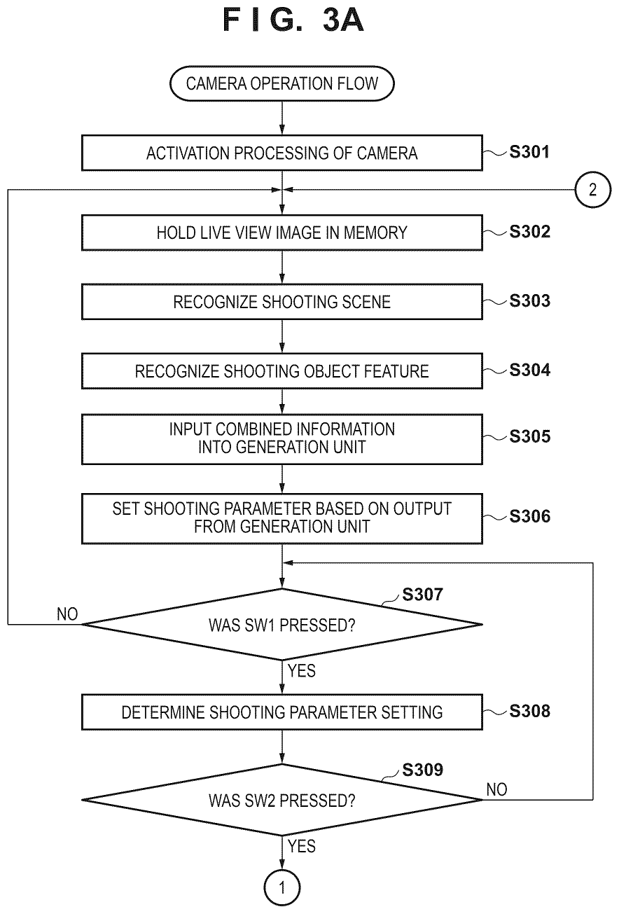

FIGS. 3A and 3B are flowcharts showing the operation of the digital camera 100 illustrated in FIGS. 1A and 1B. Each process in FIGS. 3A and 3B is implemented by the CPU 31 executing a program stored in the memory 36 to send a command to the control unit 33 and controlling each unit of the apparatus.

The processing of FIG. 3A is started when the user turns on the power of the digital camera 100, and in step S301, the CPU 31 performs activation processing of the digital camera 100.

In step S302, the CPU 31 holds a live view image in the memory 36.

In step S303, using the image processing unit 32, the CPU 31 recognizes a shooting scene based on the live view image stored in the memory 36.

In step S304, using the image processing unit 32, the CPU 31 recognizes the feature of the shooting object based on the live view image stored in the memory 36.

In step S305, the CPU 31 inputs, to the generation unit 34 as combined information, the shooting scene and the feature of the shooting object associated with each other.

In step S306, the CPU 31 sets a shooting parameter based on the output from the generation unit 34.

In step S307, the CPU 31 determines whether or not the SW1 is pressed. In a case where the SW1 is pressed, the CPU 31 proceeds with the processing to step S308, and otherwise returns the processing to step S302.

In step S308, the CPU 31 determines the shooting parameter set in step S306.

In step S309, the CPU 31 determines whether or not the SW2 is pressed. In a case where the SW2 is pressed, the CPU 31 proceeds with the processing to step S310, and otherwise returns the processing to step S307.

In step S310, the CPU 31 performs shooting with the setting of the shooting parameter determined in step S308.

In step S311, the CPU 31 displays the shot image on the rear liquid crystal device 23 or the small liquid crystal device 24.

In step S312, using the voice acquisition unit 35, the CPU 31 determines whether or not there is a user voice instruction for the shot image input to the microphone 27. In a case where there is a voice instruction, the CPU 31 proceeds with the processing to step S313, and otherwise proceeds with the processing to step S317.

In step S313, the CPU 31 converts, into a prompt, the user voice instruction input to the voice acquisition unit 35. The prompt is, for example, a verbal expression of how the user desires to modify a shot and displayed image.

In step S314, the CPU 31 further associates a prompt with the combined information in which the shooting scene and the feature of the shooting object are associated with each other, and inputs the combined information to the generation unit 34. Based on this input, the generation unit 34 generates a modified image in which a shot image is modified based on a voice instruction (prompt) from the user.

In step S315, the CPU 31 displays the modified image based on the output from the generation unit 34.

In step S316, the CPU 31 sets the shooting parameter so as to obtain a shot image such as a modified image based on the output from the generation unit 34.

In step S317, the CPU 31 determines whether or not the display mode has been released. If the display mode has been released, the CPU 31 proceeds with the processing to step S318, and otherwise returns the processing to step S312.

In step S318, the CPU 31 determines whether or not the power of the digital camera 100 has been turned off. If the power has been turned off, the CPU 31 ends the operation of the present flow, and otherwise returns the processing to step S302.

As described above, in the present embodiment, capturing is performed by the image sensor 21 based on the shooting parameter generated by the generation unit 34 having the learning model, the captured image is displayed on the small liquid crystal device 24, and an instruction for modification from the user with respect to the image displayed on the small liquid crystal device 24 is acquired. Then, the generation unit 34 generates a modified shooting parameter based on combined information in which the shooting scene and the feature of the shooting object are associated with each other and an instruction for modification from the user. This series of operations is repeated to perform learning of the learning model so as to obtain a shooting parameter desired by the user.

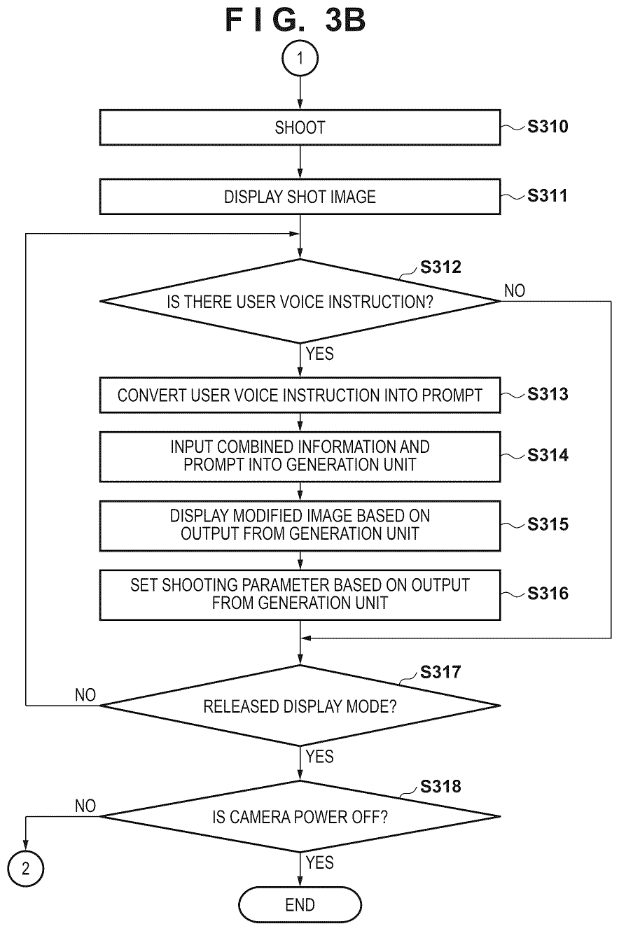

FIG. 4 is a conceptual view illustrating the operation of the camera described in FIGS. 3A and 3B. Images updated in time series and the setting of the shooting parameter will be described with reference to the conceptual view of FIG. 4.

FIG. 4 illustrates an example in which the user is shooting a player playing soccer. FIG. 4 illustrates that the user confirms a live view image, a modified image, and a shot image through the finder unit 40, and a view illustrated along the time axis illustrates display content of the small liquid crystal device 24 viewed by the user through the finder.

First, a shooting scene A recognized from the live view image at time t0 and a feature A of the shooting object are input to the generation unit 34.

At time t1, a shooting parameter setting A is output from the generation unit 34 and set in the digital camera 100.

By pressing on the SW2 at time t2, shooting is performed by the shooting parameter setting A, and a shot image A is displayed.

At time t3, the user views the shot image A and gives a user instruction I (prompt) by voice “Brighter!”, and this user instruction I is input to the generation unit 34 in association with the shooting scene A and a shooting object A.

At time t4, the user instruction I is reflected, and a brightened modified image AI and a shooting parameter setting AI for brightly shooting are output from the generation unit 34. Here, a user instruction by voice may be further given to the modified image, and this prompt may be input to the generation unit 34.

By the display mode having been released at time t5, a live view image AI is displayed, and the shooting scene A recognized from the live view image AI and the feature A of the shooting object are input to the generation unit 34.

At time t6, the shooting parameter setting AI is output from the generation unit 34 and set in the digital camera 100.

By pressing on the SW2 at time t7, shooting with the shooting parameter setting AI intended by the user is performed, and the shot image AI is displayed.

In actual shooting, as in FIG. 4, processing for generating a shooting parameter by inputting the shooting scene, the feature of the shooting object, and the user instruction is repeated along the time axis. This enables a more user-preferred image to be shot each time the user gives an instruction to the shot image.

### Learning Method of Present Embodiment

The learning model serving as a base used by the generation unit 34 is a large language model (LLM) that can perform inference processing with a shooting scene, a feature of a shooting object, and user instruction information (prompt) as input data. The learning model in the initial state is a learning model in which learning is repeated with a shooting scene and a feature of a shooting object as input data and with, as supervised data, a shooting result (shooting parameter at that time) generally considered to be appropriate for the input data. In the process of performing many shots from this initial setting state, learning of the generation unit 34 is further advanced with, as supervised data, an image (shooting parameter at that time) modified by the user instruction information (prompt) with respect to the shooting scene and the feature of the shooting object input to the generation unit 34. Doing this enables a more user-preferred learning model to be configured each time shooting is performed.

### Model Configuration of First Embodiment

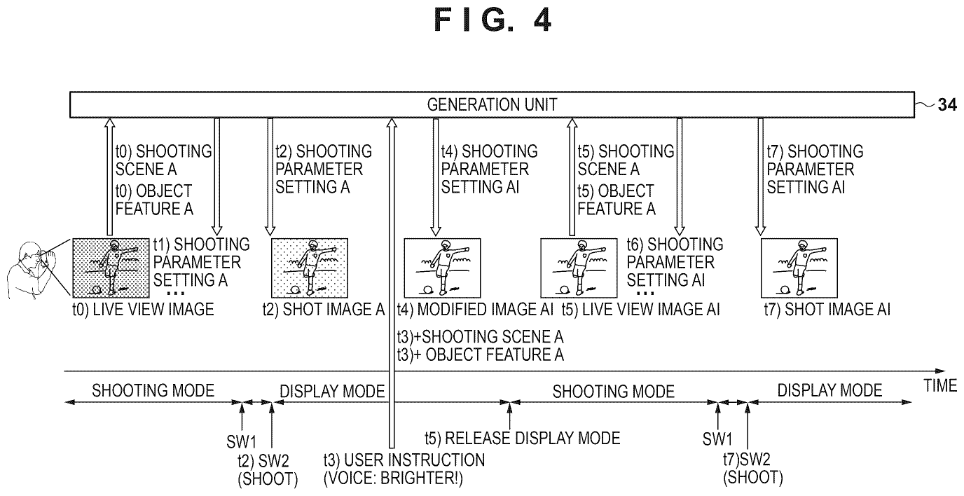

In the present embodiment, the generation unit 34 generates two things, i.e., a modified image and a shooting parameter. FIG. 5 illustrates a configuration example of the generation unit 34 including one learning model.

The live view image, the shooting scene, and the feature of the shooting object output from the image processing unit 32, and the user instruction information (prompt) output from the voice acquisition unit 35 are input to the learning model (LLM), and the modified image and the shooting parameter are output. Here, a configuration in which both the modified image and the shooting parameter are output from one learning model is assumed, but in order to reduce the model scale and shorten the processing time, a configuration in which the modified image and the shooting parameter are output separately with two divided learning models may be assumed.

### Selectivity of Input Data of Generation Unit 34

The user does not necessarily utter voice. Therefore, the generation unit 34 is configured to be able to generate a modified image and a shooting parameter when given at least a shooting scene and a feature of a shooting object as input data.

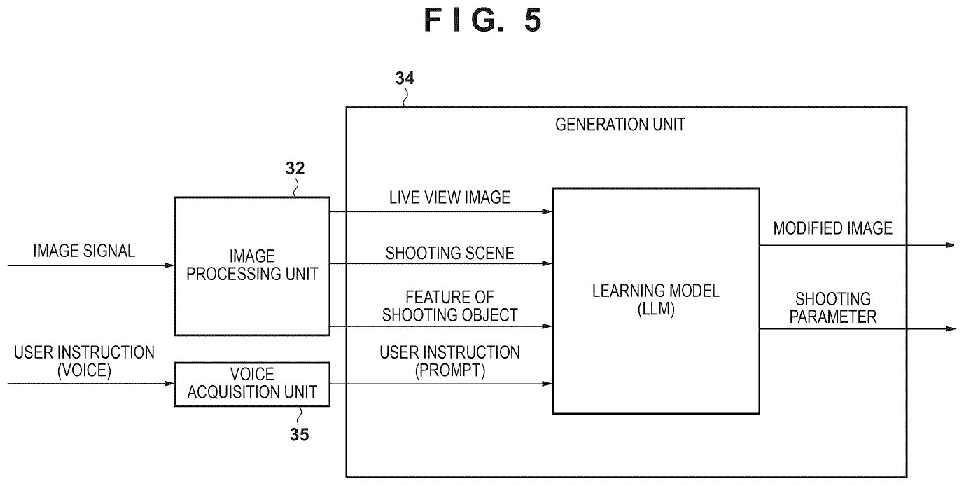

FIG. 6 is a view illustrating an example of a data array of input data of the generation unit 34 in the present embodiment.

In FIG. 6, the input data includes a header (1 or 0) indicating whether or not there is significant input information, and a payload in which data is arranged in the order of shooting scene, feature of the shooting object, user instruction (prompt), live view image, and shooting parameter associated with the live view image. Each piece of input information has a fixed length in the present embodiment, but is not limited to this, and may have a variable length and a data size may be further imparted as a header. In this manner, in the present embodiment, the data is notified to the generation unit 34 as a pair of input data.

The generation unit 34 adopts the notified significant data as input data and gives 0 as an input signal of insignificant input information. In the learning of the learning model of the generation unit 34, if learning is performed with some input data set to 0, the generation unit 34 can generate the modified image and the shooting parameter even in a case where no input data exists.

As described above, the user instruction for modifying the displayed image is input to the digital camera by voice or the like, and this user instruction is input to the learning model together with the shooting scene and the feature of the shooting object, whereby the learning model can learn a user-preferred image. This enables a parameter for shooting a more user-preferred image to be set, and an appropriate shooting assist function to be provided.

### Second Embodiment

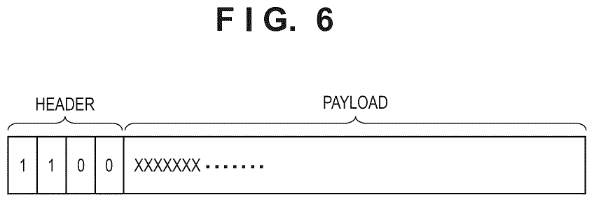

Hereinafter, a digital camera 700 of the second embodiment will be described with reference to FIGS. 7 to 12.

FIG. 7 is a view illustrating the configuration of the digital camera 700. Here, only a difference from the block diagram of the digital camera 100 illustrated in FIG. 1B describing the first embodiment will be described.

In FIG. 7, the finder unit 40 of a camera body 730 is further provided with a line-of-sight detection unit 732 that detects a gaze position of the user with respect to the small liquid crystal device 24.

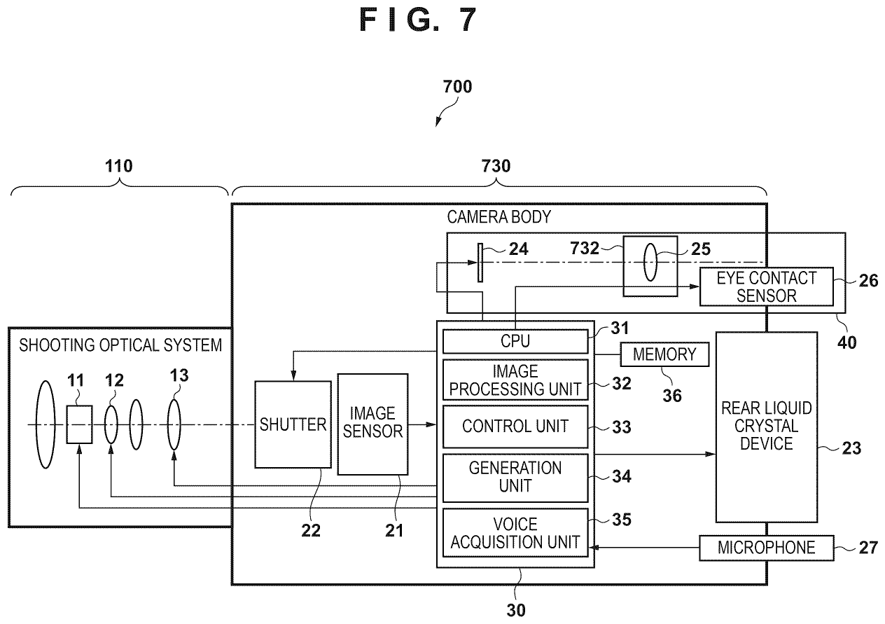

FIG. 8 is a view illustrating the configuration of the line-of-sight detection unit 732.

An illuminant 801 is a light source that projects infrared light onto an eyeball 804 for line-of-sight detection, and includes, for example, a plurality of infrared light emitting diodes. The illuminated eyeball image and the image due to corneal reflection of the light source are formed on an eyeball image sensor 803 in which a photoelectric conversion element array such as CMOS is two-dimensionally arranged by a light receiving lens 802.

The light receiving lens 802 positions the pupil of the eyeball 804 of the user and the eyeball image sensor 803 in a complementary image forming relationship. A line-of-sight direction is detected by a predetermined algorithm described later from a positional relationship between the eyeball image formed on the eyeball image sensor 803 and the image due to corneal reflection of the light source 801. Note that the illuminant 801, the light receiving lens 802, and the eyeball image sensor 803 are mechanisms that constitute the line-of-sight detection unit 732.

The memory 36 also has a storage function of image capturing signals from the image sensor 21 and the eyeball image sensor 803, and a storage function of line-of-sight correction data and eye characteristic information.

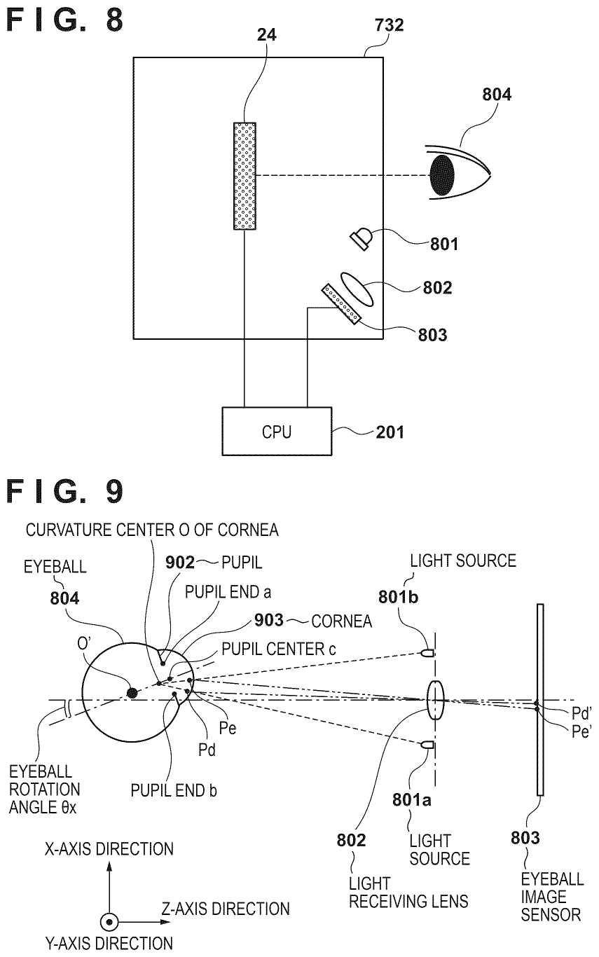

FIG. 9 is an explanatory view of a principle of a line-of-sight detection method, and corresponds to a summary view of an optical system for performing the line-of-sight detection of FIG. 8 described above.

In FIGS. 9, 801a and 801b denote light sources such as light emitting diodes that emit infrared light imperceptible to the user, and each light source is arranged substantially symmetrically with respect to the optical axis of the light receiving lens 802 and illuminates an eyeball 901 of the user. Part of the illumination light reflected by the eyeball 901 is collected on the eyeball image sensor 803 by the light receiving lens 802.

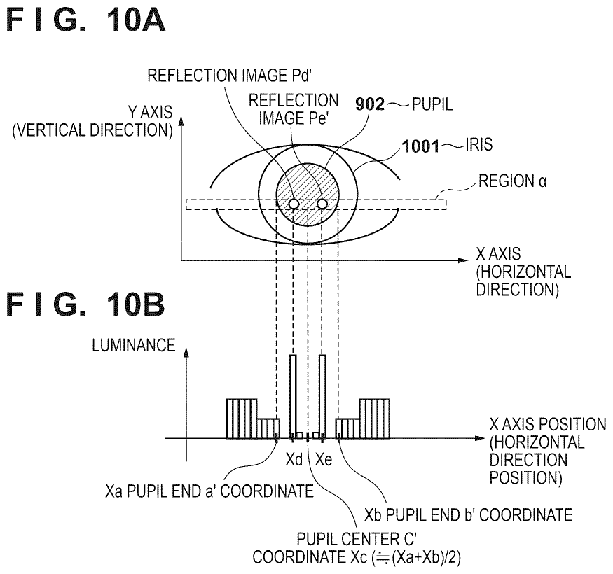

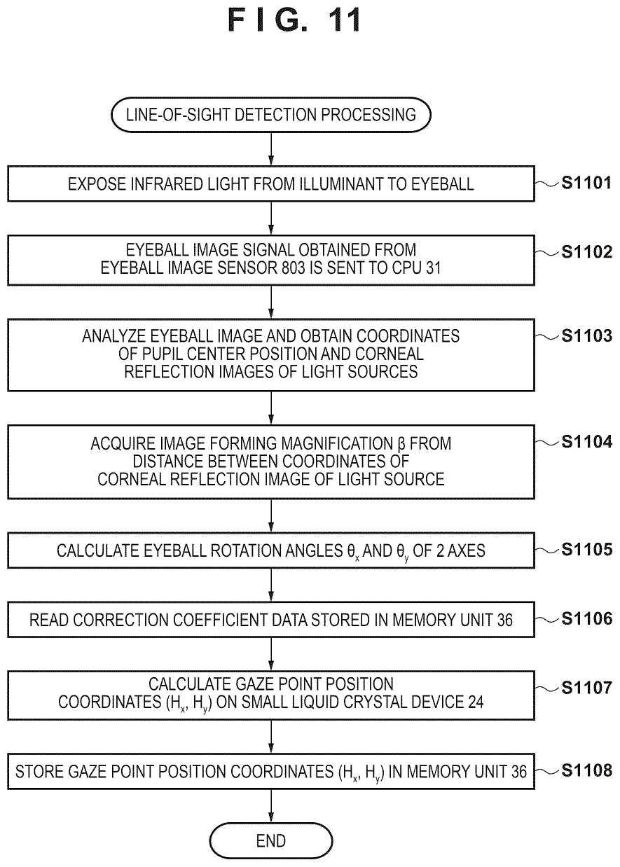

FIG. 10A is a schematic view of an eyeball image projected on the eyeball image sensor 803, and FIG. 10B is an output intensity diagram in the eyeball image sensor 803. FIG. 11 is a flowchart showing a schematic operation of line-of-sight detection processing.

Hereinafter, the line-of-sight detection method will be described with reference to FIGS. 9 to 11.

### Description of Line-of-Sight Detection Operation

In FIG. 11, when a line-of-sight detection routine is started, the CPU 31 emits in step S1101 infrared light toward the eyeball 804 of the user using the light sources 801a and 801b. The eyeball image of the user illuminated by the infrared light described above is formed on the eyeball image sensor 803 through the light receiving lens 802, subjected to photoelectric conversion by the eyeball image sensor 803, and can be processed as an electrical signal.

In step S1102, the CPU 31 acquires an eyeball image signal from the eyeball image sensor 803.

In step S1103, the CPU 31 obtains coordinates of points corresponding to corneal reflection images Pd and Pe of the light sources 801a and 801b and a pupil center c illustrated in FIG. 9 from information of the eyeball image signal obtained in step S1102. The infrared light emitted from the light sources 801a and 801b illuminates a cornea 903 of the eyeball 804 of the user. At this time, the corneal reflection images Pd and Pe formed by part of the infrared light reflected by the surface of the cornea 903 are collected by the light receiving lens 802 and formed on the eyeball image sensor 803 (illustrated points Pd′ and Pe′). Similarly, light fluxes from end portions a and b of a pupil 902 are also formed on the eyeball image sensor 803.

FIG. 10A illustrates an image example of a reflection image obtained from the eyeball image sensor 803, and FIG. 10B illustrates a luminance information example obtained from the eyeball image sensor 803 in a region α of the image example described above. As illustrated, the horizontal direction is an X-axis, and the vertical direction is a Y-axis. At this time, coordinates in the X-axis direction (horizontal direction) of the images Pd′ and Pe′ on which the corneal reflection images of the light sources 801a and 801b are formed are Xd and Xe. Coordinates in the X-axis direction of images a′ and b′ on which the light fluxes from the end portions a and b of the pupil 902 are formed are Xa and Xb.

In the luminance information example of FIG. 10B, an extremely strong level of luminance is obtained at the positions Xd and Xe corresponding to the images Pd′ and Pe′ on which the corneal reflection images of the light sources 801a and 801b are formed. In a region between the coordinates Xa and Xb corresponding to the region of the pupil 902, an extremely low level of luminance can be obtained except for the positions Xd and Xe. On the other hand, in a region having the value of an X-coordinate lower than Xa and a region having the value of the X-coordinate higher than Xb, which correspond to the region of an iris 1001 outside the pupil 902, an intermediate value between the above-described two types of luminance levels is obtained.

From variation information of the luminance level with respect to the X-coordinate position, it is possible to obtain the X-coordinates Xd and Xe of the images Pd′ and Pe′ on which the corneal reflection images of the light sources 801a and 801b are formed and the X-coordinates Xa and Xb of the images a′ and b′ of the pupil ends. In a case where a rotation angle θx of the optical axis of the eyeball 901 with respect to the optical axis of the light receiving lens 802 is small, a coordinate Xc of an area (c′) corresponding to the pupil center c formed on the eyeball image sensor 803 can be expressed as Xc≈(Xa+Xb)/2. As described above, the X-coordinate of c′ corresponding to the pupil center formed on the eyeball image sensor 803 and the coordinates of the corneal reflection images Pd′ and Pe′ of the light sources 801a and 801b can be estimated.

Returning to the description of FIG. 11, in step S1104, the CPU 31 calculates an image forming magnification β of the eyeball image. β is a magnification determined by the position of the eyeball 901 with respect to the light receiving lens 802, and can be substantially obtained as a function of an interval (Xd-Xe) between the corneal reflection images Pd′ and Pe′.

In step S1105, the CPU 31 calculates a rotation angle of the eyeball 901. Since the X-coordinate of a midpoint between the corneal reflection images Pd′ and Pe′ and the X-coordinate of a curvature center O of the cornea 903 substantially coincide with each other, when a standard distance between the curvature center O of the cornea 903 and the center c of the pupil 902 is Oc, the rotation angle θX in a Z-X plane of the optical axis of the eyeball 901 can be obtained from a relational expression β*Oc*SINθX≈{(Xd+Xe)/2}−Xc. FIGS. 9, 10A, and 10B illustrate an example of calculating the rotation angle θX in a case where the user's eyeball rotates in a plane perpendicular to the Y-axis, but a calculation method of a rotation angle θy in a case where the user's eyeball rotates in a plane perpendicular to the X-axis is similar.

When the rotation angles θx and θy of the optical axis of the eyeball 901 of the user are calculated in step S1105, the CPU 31 obtains the position of the line-of-sight of the user in steps S1106 and S1107. Specifically, the position (gaze point) of the line-of-sight of the user on the small liquid crystal device 24 is obtained using θx and θy. Assuming that the gaze point position is coordinates (Hx, Hy) corresponding to the center c of the pupil 902 on the small liquid crystal device 24,

$$Hx = m \times ( A x \times θ x + Bx ) \\ Hy = m \times ( A y \times θ y + B y )$$

can be calculated. A coefficient m is a constant determined by the configuration of the optical system, is a conversion coefficient for converting the rotation angles θx and θy into position coordinates corresponding to the center c of the pupil 902 on the small liquid crystal device 24, and is determined in advance to be stored in the memory 36. It is assumed that Ax, Bx, Ay, and By are line-of-sight correction coefficients for correcting individual differences in the line-of-sight of the user, are acquired by performing calibration work, and are stored in the memory 36 before the line-of-sight detection routine is started.

After the coordinates (Hx, Hy) of the center c of the pupil 902 on the small liquid crystal device 24 are calculated as described above, the coordinates are stored in the memory 36 in step S1108, and the line-of-sight detection routine is ended.

In the above, a gaze point coordinate acquisition method on the small liquid crystal device 24 using the corneal reflection images of the light sources 801a and 801b has been presented, but the present disclosure is not limited to this, and any method that can acquire the eyeball rotation angle from a captured eyeball image can be applied to the present embodiment.

### Camera Operation Flow

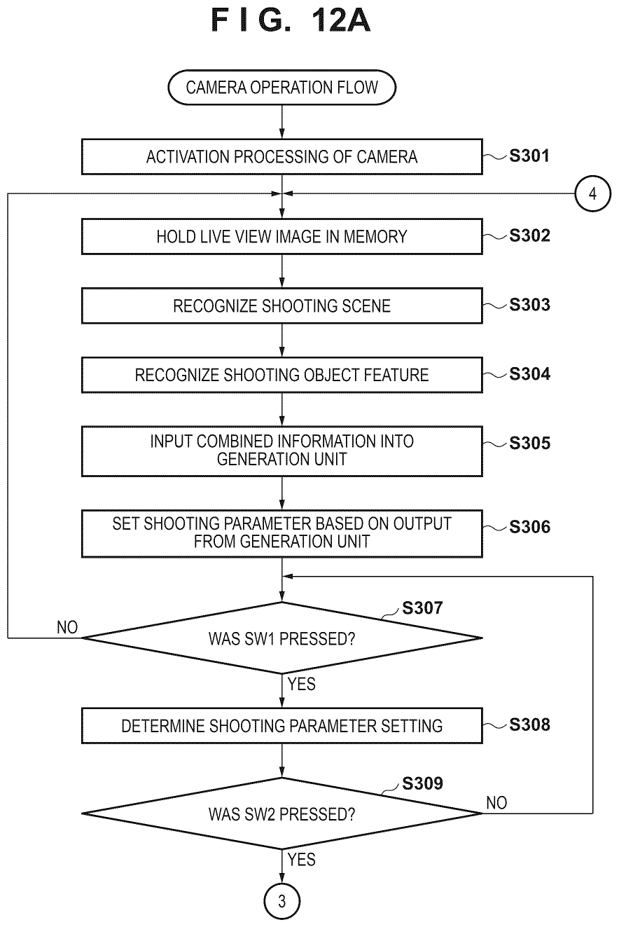

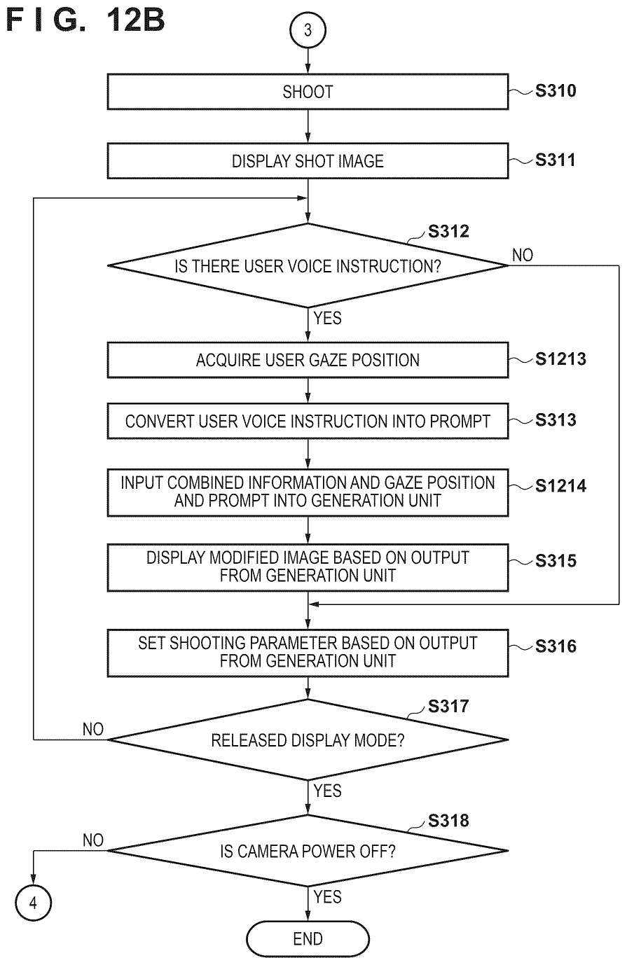

Next, the operation of the digital camera 700 in the second embodiment will be described with reference to FIGS. 12A and 12B. Here, steps for performing the same operations as the operations of the digital camera 100 illustrated in FIG. 3 described in the first embodiment are denoted by the same step numbers, and only parts different from those in FIG. 3 will be described.

In step S1213, the CPU 31 acquires the gaze position of the user on the small liquid crystal device 24 from the line-of-sight detection unit 732. In step S1214, the combined information in which the shooting scene and the feature of the shooting object are associated with each other, the gaze position of the user, and the prompt (user instruction) are associated with each other and input to the generation unit 34.

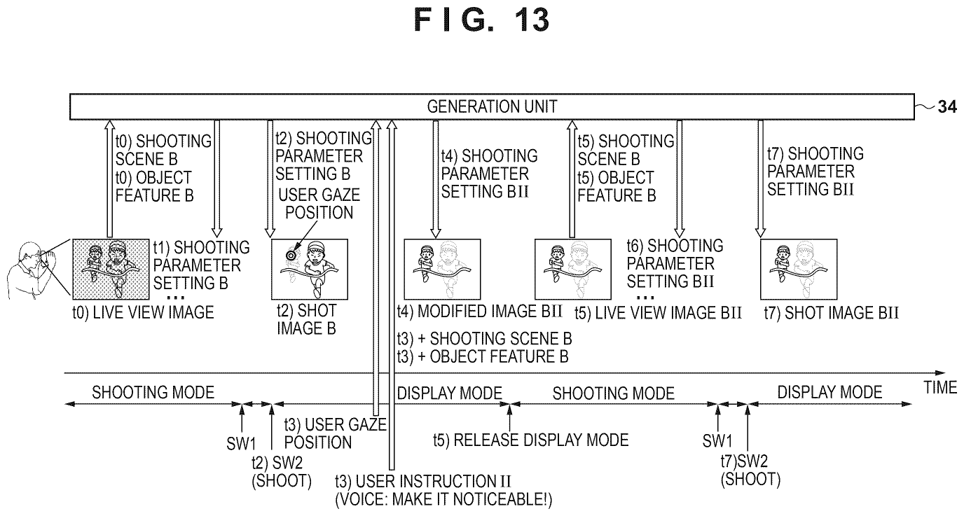

FIG. 13 is a conceptual view illustrating the operation of the camera described in FIGS. 12A and 12B. Images updated in time series and the setting of the shooting parameter will be described with reference to the conceptual view of FIG. 13.

FIG. 13 illustrates an example in which the user is shooting a scene in which two children are running toward a goal in a sports festival. FIG. 13 illustrates that the user confirms a live view image, a modified image, and a shot image through the finder unit 40, and a view illustrated along the time axis illustrates display content of the small liquid crystal device 24 viewed by the user through the finder.

First, a shooting scene B recognized from the live view image at time t0 and a feature B of the shooting object are input to the generation unit 34.

At time t1, a shooting parameter setting B in which the player with the ball is a main person is output from the generation unit 34 and set in the digital camera 700.

By pressing on the SW2 at time t2, shooting is performed by the shooting parameter setting B, and a shot image B is displayed on the small liquid crystal device 24.

By the user viewing the shot image B at time t3, the gaze position of the user on the small liquid crystal device 24 is calculated. At the same time, the user views the shot image and gives a user instruction II (prompt) by voice “Make it noticeable!”, and the gaze position of the user and the user instruction II are input to the generation unit 34 in association with the shooting scene B and a shooting object B.

At time t4, the user instruction II is reflected, and a modified image BII modified so as to make the child present at the gaze position noticeable and a shooting parameter setting BII for shooting so as to make the child present at the gaze position noticeable are output from the generation unit 34.

By the display mode having been released at time t5, a live view image BII is displayed, and the shooting scene B recognized from the live view image BII and the feature B of the shooting object are input to the generation unit 34.

At time t6, the shooting parameter setting BII is output from the generation unit 34 and set in the digital camera 700.

By pressing on the SW2 at time t7, shooting with the shooting parameter setting BII intended by the user is performed, and the shot image BII is displayed.

Although the user instruction by voice input alone does not make it clear which region in the shot image the instruction is for, the intention of the user is reflected in the camera by further inputting the gaze position of the user to the generation unit 34 as described above. Then, shooting can be performed with a shooting parameter more appropriate for the user.

### Learning Model Configuration of Second Embodiment

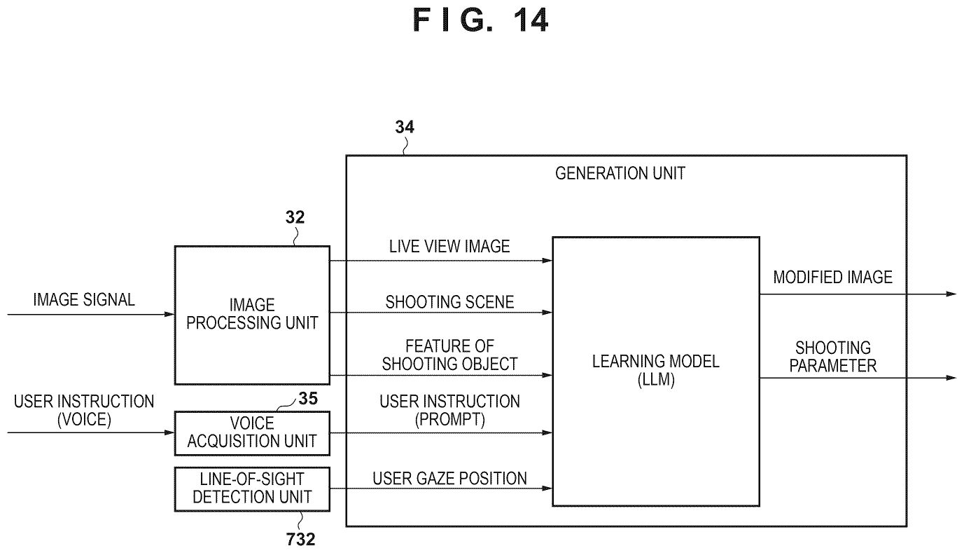

Also in the second embodiment, the generation unit 34 generates two things, i.e., a modified image and a shooting parameter. FIG. 14 is a view illustrating a configuration example of the generation unit 34 including one learning model.

With respect to the configuration of FIG. 5 in the first embodiment, information on the gaze position of the user on the small liquid crystal device 24 from the line-of-sight detection unit 732 is further input to the learning model. The gaze position of the user is input to the learning model in association with the shooting scene, the feature of the shooting object, and the user instruction (prompt), and the modified image and the shooting parameter are output.

In the first embodiment, there is a case where it is unclear which region in the live view image the user instruction (prompt) is for. On the other hand, in the present embodiment, by adding the information on the gaze position of the user on the small liquid crystal device 24, the intention of the user is more reflected in the modified image and the shooting parameter.

Note that in the first and second embodiments, an example in which the large language model is used as a learning model has been described, but another AI learning model may be used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-217758, filed Dec. 12, 2024, which is hereby incorporated by reference herein in its entirety.

What is claimed is:

1. An image capturing apparatus comprising:
an image capturing device that captures a subject to acquire an image signal; and
at least one processor or circuit and a memory storing instructions to cause the at least one processor or circuit to perform operations of the following units:
a recognition unit that recognizes a shooting scene and a feature of a shooting object based on the image signal,
a generation unit that generates a shooting parameter of the image capturing device corresponding to combined information by using a learning model that learns a relationship between the combined information associating the shooting scene with the feature of the shooting object and a shooting parameter that gives an appropriate shooting result with respect to the combined information,
a display device that displays the image captured with the image capturing device based on the shooting parameter generated by the generation unit,
an acquisition unit that acquires an instruction for modification from a user with respect to an image displayed on the display device, and
a control unit that performs capturing with the image capturing device based on the shooting parameter generated by the generation unit, displays a captured image on the display device, acquires the instruction for modification from the user with respect to the image displayed on the display device, and repeats a series of operations of generating a modified shooting parameter of the image capturing device by the generation unit based on the combined information and the instruction for modification from the user to perform learning of the learning model so as to obtain a shooting parameter desired by the user.

2. The image capturing apparatus according to claim 1, wherein the learning model is a learning model learned with the combined information as input and with, as supervised data, the shooting parameter that gives an appropriate shooting result with respect to the combined information.

3. The image capturing apparatus according to claim 1, wherein the learning model further performs learning with the modified shooting parameter as supervised data.

4. The image capturing apparatus according to claim 1, wherein the learning model is a large language model.

5. The image capturing apparatus according to claim 1, wherein the instruction for modification from the user is an instruction by user voice.

6. The image capturing apparatus according to claim 1 further comprising a detection unit that detects a gaze position of the user with respect to an image displayed on the display device.

7. The image capturing apparatus according to claim 6, wherein the learning model learns a relationship between the combined information and the shooting parameter further based on information from the detection unit.

8. The image capturing apparatus according to claim 1, wherein the generation unit further generates a modified image in which the image displayed on the display device is modified based on the instruction for modification from the user.

9. The image capturing apparatus according to claim 8, wherein the display device further displays the modified image.

10. A control method of an image capturing apparatus including an image capturing device that captures a subject to acquire an image signal, the control method comprising:
recognizing a shooting scene and a feature of a shooting object based on the image signal;
generating a shooting parameter of the image capturing device corresponding to combined information by using a learning model that learns a relationship between the combined information associating the shooting scene with the feature of the shooting object and a shooting parameter that gives an appropriate shooting result with respect to the combined information,
displaying an image captured by the image capturing device based on the shooting parameter generated by the generating;
acquiring an instruction for modification from a user with respect to the image displayed by the displaying; and
performing capturing with the image capturing device based on the shooting parameter generated in the generating, displaying a captured image in the displaying, acquiring the instruction for modification from the user with respect to the image displayed by the displaying, and repeating a series of operations of generating a modified shooting parameter of the image capturing device by the generating based on the combined information and the instruction for modification from the user to perform learning of the learning model so as to obtain a shooting parameter desired by the user.

11. A non-transitory computer-readable storage medium storing a program for causing a computer to function as each unit of an image capturing apparatus, the image capturing apparatus including:
an image capturing device that captures a subject to acquire an image signal,
a recognition unit that recognizes a shooting scene and a feature of a shooting object based on the image signal,
a generation unit that generates a shooting parameter of the image capturing device corresponding to combined information by using a learning model that learns a relationship between the combined information associating the shooting scene with the feature of the shooting object and a shooting parameter that gives an appropriate shooting result with respect to the combined information,
a display device that displays the image captured with the image capturing device based on the shooting parameter generated by the generation unit,
an acquisition unit that acquires an instruction for modification from a user with respect to an image displayed on the display device, and
a control unit that performs capturing with the image capturing device based on the shooting parameter generated by the generation unit, displays a captured image on the display device, acquires the instruction for modification from the user with respect to the image displayed on the display device, and repeats a series of operations of generating a modified shooting parameter of the image capturing device by the generation unit based on the combined information and the instruction for modification from the user to perform learning of the learning model so as to obtain a shooting parameter desired by the user.
